(19) United States
(12) Patent Application Publication
(10) Pub. No.: US 2013/0175770 A1
(43) Pub. Date: Jul. 11, 2013

(54) Evacuation Chair

(71) Applicants: Gerald David Morrish, Hatfield (GB); Kenneth George Morrish, Hatfield (GB)

(72) Inventors: Gerald David Morrish, Hatfield (GB); Kenneth George Morrish, Hatfield (GB)

(21) Appl. No.: 13/813,570

(22) PCT Filed: Jul. 29, 2011
(86) PCT No.: PCT/GB11/01143

§ 371 Date: Mar. 19, 2013

(30) Foreign Application Priority Data
Aug. 2, 2010 (GB) 1013014.4

(51) Int. Cl. A61G 5/06; B26D 3/00

(52) U.S. Cl. CPC A61G 5/06; A61G 5/066; B26D 3/00
USPC 280/5.22; 280/5.2; 83/13

(57) ABSTRACT

An evacuation chair is disclosed for evacuating a person down stairs and along level ground. The evacuation chair has a frame and at least one front wheel and at least two rear wheels attached and rotatable with respect to the frame to allow the chair to be wheeled along level ground. The evacuation chair also has two rail assemblies attached with respect to the frame, each rail assembly extending rearwardly and upwardly from a forward end of the rail assembly to a rearward end thereof, the rail assemblies being provided for guiding the movement of the evacuation chair on stairs. A clear space is provided extending throughout a legroom region between the rail assemblies from the rearward ends thereof to at least halfway towards the forward ends thereof, to accommodate the movement of the legs of the operator. The rail assemblies have a belt for movement around the rail assembly, to bear between the stairs and the rail assembly. The belt has an inner surface for bearing against the rail assembly, an outer surface, and a maximum lateral width Wm. The outer surface of the belt includes an outer contact region for contacting the stairs, the outer contact region having a lateral width W. such that the ratio W_{c}/Wₘ, is 0.5 or lower.

### BACKGROUND TO THE INVENTION

1. Field of the Invention

The present invention relates to an evacuation chair for evacuating a person down a set of stairs.

2. Related art

In an emergency, such as a fire, buildings must be evacuated. For safety reasons, the use of most lifts is prohibited, so the building is evacuated via standard or emergency stair cases. This means that people with mobility difficulties, unable to descend the stair case unassisted, require help to safely evacuate the building. It is not considered safe to use a standard wheelchair on a stair case, nor is it safe to ask an able-bodied person to carry the person with mobility difficulties down the stairs. Therefore it is usually recommended that an evacuation chair is used.

One of the main differences between an evacuation chair and a standard wheelchair is the provision of rail assemblies for safely descending stair cases. FIG. 1 shows a known evacuation chair, from U.S. Pat. No. 6,561,524. With reference to FIG. 1, the rail assemblies 42 are oriented at an acute angle with respect to a generally upright direction of the chair so that the chair can be tilted on to the rail assemblies for descent down a stair case, with the rail assemblies making contact with two or more stairs at a time, in order to lend stability to the progress of the evacuation chair down the stairs. The person being evacuated is seated in the chair, safely located due to the tilting of the chair.

The evacuation chair of FIG. 1 is now described in more detail. The evacuation chair, indicated generally at 10, has three frame assemblies pivotally connected together: a rear assembly, a seat assembly and a front assembly. The pivotal connections of the frame assemblies allow the chair to be folded for ease of storage. The rear assembly has two rear legs 12 with respective rear wheels 14 attached. The rear legs are connected together by: a rear axle 16 extending between two rear wheels; a lower cross bar 18 above and parallel to the axle; and an upper cross bar 20 (shown behind seat 28). A handle 22 is attached to the rear legs using two respective attachment members (not shown).

The rear assembly is pivotally connected to the seat assembly about two laterally spaced pivot points 24 located on respective rear legs 12 between the lower and upper cross bars of the rear assembly. The seat assembly has a support member 26 that defines a seating area. The seat 28 is completed by attaching a piece of flexible material, e.g. fabric, to the upper cross bar of the rear assembly and to the support member 26 of the seat assembly.

The front assembly is pivotally connected to the seat assembly, about two laterally spaced pivot points 30 at the front of the seat assembly. The front assembly has two front legs 32, each having a respective front wheel 34 attached. The two front legs are connected to two respective side support members 36 that extend to a pivotal connection with the rear legs. The two side support members are connected at the front of the evacuation chair by a foot rest 38. A front cross bar 40 also connects the front legs together.

Two rail assemblies 42 are connected to the rear frame at the rear axle 16 and extend rearwardly at an angle to the upward direction of the evacuation chair 10. A rail brace 44 connects the two rail assemblies at a position close to the end of the rail assembly, rearwardly from the rear axle 16. In use, the rail brace 44 and a rail support bar 45 maintain substantially the same spacing of the rail assemblies along the length thereof. The rail support bar 45 extends from two respective pivotal connections with the rear frame to have a portion parallel with the rail brace. In an unfolded configuration of the evacuation chair, the rail brace is connected to the support bar using, for example, a clip and a belt.

Each rail assembly 42 comprises two laterally opposing rail members and a linear series of rollers positioned for rotation between the opposing rail members. A continuous belt is arranged on the outer surface of the rollers and is constrained to move around the rail assembly. In use, the belt contacts the stairs, and the ability of the belt to move around the rail assembly enables controlled descent of the chair down the stairs.

A modification to the evacuation chair of U.S. Pat. No. 6,561,524 includes fewer rollers; this can be as few as two rollers.

In other known evacuation chairs, suitable belts for the rail assemblies are designed to have a trapezoidal shape, as shown in FIG. 2, and are in the form of a continuous loop. An inner surface 46 of the belt bears against the rollers, and an outer surface 48 of the belt, in use, contacts the stairs. This belt is conventionally manufactured by modifying a standard vehicle fan belt to create a belt of reduced total thickness appropriate for movement around the rail assembly.

An alternative type of belt has a caterpillar tread for contacting the stairs, and is significantly more complex and expensive to manufacture than the belt of FIG. 2.

In use, the chair of U.S. Pat. No. 6,561,524 is placed in an unfolded configuration (as shown in FIG. 1), and a person is seated in seat 28. One or more safety restraints may be used to hold the person securely in the seat. The front and rear wheels 34 and 14 allow movement of the chair on level ground, and the chair can be manoeuvred using the handle 22. When the chair reaches a stair case, the operator can use the handle to tilt the chair on to the rail assemblies 42. The chair can then be eased over the first stair so that the stair contacts the belt around the rail assemblies. As the chair is allowed to move down the stairs (under the influence of gravity) the belt contacts progressively more stairs, aiding a steady and controlled descent. Again, the handle can be used to help manoeuvre the chair and also support the chair during descent. When the chair reaches the bottom of the stair case, the chair can be tilted back onto the front and rear wheels to again travel on level ground.

### SUMMARY OF THE INVENTION

Typical known evacuation chairs require a rail brace 44 or similar to maintain substantially the same spacing of the rail assemblies along the length thereof, when descending the stairs. Maintaining the spacing between the rail assemblies during descent down stairs is important in order to ensure that the belts are guided continuously around the rail assemblies—divergence or convergence of the rail assemblies can lead to the belts being guided off the rail assemblies. However, when the evacuation chair is moving on level ground, the rail assemblies are not load supporting, and as such the rail brace is not necessarily required. The present inventors consider that an ergonomic, comfortable and efficient position for an operator is for the operator to push the chair when the operator is close to the handle of the chair. In this case, the operator's legs would be positioned, when walking, in the space occupied by the rail brace and rail support bar. Collision of the operator's legs (and especially shins) with the rail brace or rail support bar can be exceptionally painful, with the result that such a collision could cause the operator to lose control of the evacuation chair. Similarly, there can be a difficulty for the operator when tilting the chair before descending stairs.

In a first aspect of the invention, the present inventors aim to address this problem.

Accordingly, in a first preferred aspect, the present invention provides an evacuation chair for evacuating a person down stairs and along level ground, the evacuation chair being for operation by an operator, the evacuation chair having:
a frame and at least one front wheel and at least two rear wheels attached and rotatable with respect to the frame to allow the chair to be wheeled along level ground;
two rail assemblies attached with respect to the frame, each rail assembly extending rearwardly and upwardly from a forward end of the rail assembly to a rearward end thereof, the rail assemblies being provided for guiding the movement of the evacuation chair on stairs;

wherein the chair has a folded configuration and an unfolded configuration and the rail assemblies are attached to the frame so that the rail assemblies are deployed for operation due to the chair being moved between the folded configuration and the unfolded configuration, and wherein there is provided a clear space extending throughout a legroom region between the rail assemblies from the rearward ends thereof to at least halfway towards the forward ends thereof, to accommodate the movement of the legs of the operator.

In this way, the operator is able to walk relatively close to the chair by positioning part of his/her front walking leg in the legroom region between the rail assemblies. As will be apparent, it is preferred that the clear space also extends rearwardly of the rearwards ends of the rail assemblies, in order to provide space for the operator to be located behind the chair. Advantageously, the clear space enables the operator pushing the chair to walk close behind the frame of the evacuation chair, at least when wheeling the chair along level ground. This ensures the operator is able to push the chair in an ergonomic position, which also improves the ease with which an operator can move the chair.

The evacuation chair of the first aspect may have any one or, to the extent that they are compatible, any combination of the following optional features.

Preferably, when the chair is upright on level ground, the legroom region extends downwardly from between the rail assemblies to the ground.

Preferably, when the chair is upright on level ground, the legroom region extends upwardly from between the rail assemblies to at least the frame.

Preferably the legroom region extends at least two thirds of the length of the rail assembly. More preferably the legroom region extends at least three quarters of the length of the rail assembly. Yet more preferably, the legroom region extends from the rearwards ends of the rail assemblies to the frame. Still more preferably, the legroom region extends from the rearwards ends of the rail assemblies to a bracing member aligned with axes of rotation of the rear wheels.

Advantageously, increasing the extent of the vacant region reduces the risk of the operator hitting their leg on any part of the evacuation chair.

In the unfolded configuration, preferably each rail assembly is supported by a rail support member extending longitudinally (i.e. extending in the forwards and rearwards directions) between the rail assembly to the frame of the chair. For example, each the rail support member may be attached to a respective rear leg of the chair. In this way, each rail assembly is provided with suitable support with respect to the frame in order to maintain the position of the rail assembly with respect to the frame when conveying a person in the chair down stairs.

Preferably, the rearwards end of the rail support member is slidable (or, more generally, moveable) with respect to the rail assembly, in order to transform the chair between the folded and unfolded configurations. The rail assembly may define a rearwards sliding limit for the rearwards end of the rail support member, at which limit the chair is in the unfolded configuration. Sliding the rail support member forwardly with respect to the rail assembly preferably transforms the chair towards the folded configuration. In order to accommodate this sliding of the rail support member with respect to the rail assembly, preferably the rail support member is pivotally attached to the frame of the chair. Furthermore, preferably the rail assemblies are pivotally attached at their forward ends with respect to the frame. This allows the chair to have a compact form in the folded configuration.

Forwardly of the attachment between the rail support member and the frame, the rail support member may be integrally formed with a seat member. Preferably, the seat member extends to provide a support for a seat. The seat member may extend substantially in a U-shape, so that the rail support members are connected to each other via the seat member. This provides the rail support members with rigidity, to oppose relative movement of the rail support members and thus to oppose relative movement of the rail assemblies.

Preferably, sliding of the rearwards end of the rail support member is accommodated by at least one slot formed in the rail assembly. At the rearwards sliding limit for the rearwards end of the rail support member in the rail assembly, there may be formed locking means in order to lock the position of the rail support member with respect to the rail assembly, and thus to lock the chair in the open configuration. The lock means may be provided with indicator means to indicate that the position of the rail support member is correctly locked with respect to the rail assembly. This ensures reliable transformation of the chair to the open configuration and improves the safety of the chair.

As mentioned above, the evacuation chair may further comprise two rear legs attached to respective rear wheels, and a bracing member extending between the rear legs in alignment with the centres of rotation of the rear wheels. The wheels may be mounted for rotation on the bracing member. Advantageously, using a bracing member in this way removes the need for one or more separate rear axles. Thus the evacuation chair has a reduced number of components, reduced weight and is easier and cheaper to manufacture.

Preferably, the rear legs of the evacuation chair each comprise an upward hollow tube. These are preferably located in register with the back of a seat in the chair. The chair preferably further comprises two extension components connected to a handle, the handle being for manoeuvring the chair. The handle may be formed integrally with the extension components. The extension components are preferably dimensioned to fit within the rear legs of the frame for slidable extension and retraction of the handle. Preferably the extension components are lockable in position with respect to the rear legs at one or more selectable extension positions. Preferably, two or more extension positions are provided, differing from each other in the degree of extension of the extension components with respect to the rear legs.

It has previously been known to attach extension components to upward components of the frame using a figure of eight component, such that slidable extension and retraction of the handle is accommodated by movement of the extension components next to (rather than within) the upward components of the frame. Provision of extension components dimensioned to fit within legs of the frame itself removes the need for the figure of eight component. Advantageously, reducing the number of components required to manufacture a chair eases the production process, reduces manufacturing costs and reduces weight.

A head support may be provided between the extension components, for supporting the head of a person sitting in the chair. This is of important particularly when the chair is tipped backwards for moving down stairs.

Preferably, the upper ends of front legs pivotally connect to a forward part of the seat member. The front legs extend generally downwardly (when the seat is in an unfolded configuration and is upright on level ground). A respective front wheel is attached to the lower end of each front leg. Each front leg is preferably connected to a respective side support member to a rear leg of the chair. Each side support member is preferably pivotally attached to the respective front leg and to the respective rear leg. This allows easy folding of the chair into and out of the folded configuration. Preferably, the lower ends of the front legs are braced with respect to each other by a front brace member. Preferably the front brace member also provides a footrest, discussed in further detail below.

In known evacuation chairs, during stair descent, the rollers of the rail assemblies may suffer from a problem in which they stick (i.e. are unable to roll). This can be caused by various factors. The non-rotation of the rollers provides increased resistance to the rotation of the belt around the rail assemblies. However there is still a gravitational force and/or a force applied by the operator urging the chair down the stairs. This can causes the belt, and therefore the evacuation chair, to slip on the stair nosing. This slippage can result in material removal from the belt, and consequently a reduction in the life of the belt. Such slippage can also cause a reduction (or even loss) of control over the chair by the operator. Furthermore, the material removed from the belt is typically deposited on the stair nosing, which often results in an undesirable skid mark on the stair nosing.

In a second aspect of the invention, the inventors seek to address one or more of these problems.

Accordingly, in a second preferred aspect, the present invention provides an evacuation chair having at least one rail assembly for facilitating movement of the evacuation chair on stairs and at least one belt, the belt being for movement around the rail assembly, to bear between the stairs and the rail assembly, the belt having an inner surface for bearing against the rail assembly, an outer surface, and a maximum lateral width Wₘ;
wherein the outer surface of the belt includes an outer contact region for contacting the stairs, the outer contact region having a lateral width W_{c} such that the ratio W_{c}/Wₘ is 0.5 or lower.

An outer contact region is defined as the region of contact when the evacuation chair is positioned on flat ground and loaded with a mass corresponding to 80 kg mass per metre length of belt in contact with the ground (including the initial mass of the unloaded chair), when the evacuation chair is oriented so that the belt makes contact with the flat ground. 80 kg mass is chosen since this is a typical weight of the chair plus a person seated in the chair (although of course it is possible for the chair to carry loads greater than this). “Per metre” is chosen since the length of the belt in contact with the ground is typically of the order of one metre, although it can of course be greater or less than one metre. The outer contact region can be measured by covering the outer surface of the belt with ink, placing the belt and chair in combination on flat ground and loading with a mass corresponding to 80 kg mass per metre length of belt in contact with the ground. The belt and chair can then be removed and the width of the contact region measured. It is noted that this definition is chosen in order to avoid the need to measure the actual contact region when the belt is in contact with a stair, since the corner profile of stairs is variable. Furthermore, different chairs may use different lengths for the rail assemblies and thus different lengths of belt in contact with the ground, and so it is appropriate to define the mass loaded into the chair in terms of the mass loaded into the chair per unit length of belt in contact with the ground. Typically, the width of the outer contact region when the chair is positioned on flat ground will be lower that the width of the outer surface of the belt that makes contact with a stair under similar conditions.

When the belt of an evacuation chair contacts a stair, the belt deforms around the stair nosing. To enable the chair to continue to move down the stairs without movement of the belt (i.e. slipping of the belt), a force tangential to the stair nosing, sufficient to displace the deformed belt in the path of the stair nosing, is required. Thus it follows that the more the belt deforms, the greater the tangential force required to move the belt, that is, the greater the friction between the belt and the stair. Advantageously, a belt having a contact region of lateral width such that the ratio W_{c}/Wₘ is 0.5 or lower increases the deformation of the belt at the stair contact, such that preferably in substantially all situations the friction between the belt and the stair is greater than the friction between the belt and rail assembly. Thus, if a component of the rail assembly temporarily resists movement of the belt, this resistance is preferably overcome before the belt slips on the stair nosing, thus reducing the risk of damage to the belt and stair.

The evacuation chair of the second aspect may have any one or, to the extent that they are compatible, any combination of the following optional features. The second aspect may be combined with the first aspect and/or any optional feature thereof, to the extent that they are compatible.

Typically, the belt may decrease in lateral width from the maximum width Wₘ to the contact region. Advantageously, this helps maintain the stability of the belt, whilst allowing increased belt deformation at the contact region.

The inner surface may be of maximum lateral width Wₘ. This further advantageously improves the stability of the belt bearing on the rail assembly.

The contact region may include a longitudinal ridge.

In some preferred embodiments, the rate of lateral width decrease, with distance from the inner surface of the belt, is greater near the contact region than near the position of maximum lateral width Wₘ. Advantageously this further increases the deformation near the contact region than near the position of maximum width. This therefore increases friction between the belt and the stair without compromising the stability of the belt and therefore the chair.

Typically, the contact region is formed from two or more planar belt surfaces.

Preferably, the maximum lateral width Wₘ is at least 10 mm. More preferably, the maximum lateral width Wₘ is at least 15 mm or at least 20 mm. Preferably, the maximum lateral width Wₘ is at most 60 mm. More preferably, the maximum lateral width Wₘ is at most 50 mm.

Preferably, the lateral width of the contact region W_{c} is such that the ratio W_{c}/Wₘ is 0.4 or lower. More preferably, the lateral width of the contact region W_{c} is such that the ratio W_{c}/Wₘ is 0.3 or lower, 0.2 or lower, or 0.1 or lower.

The belt may have a substantially continuous profile along its length. Accordingly, caterpillar-type belts where the tread height varies along the longitudinal direction of the belt are expressly not preferred.

In a third preferred aspect, the present invention provides a method of manufacturing an evacuation chair of the second aspect, including a step of forming the contact region of the belt by cutting from a precursor belt.

The precursor belt may, for example, be a vehicle fan belt. Alternatively, a different pulley belt may be used. For example, an industrial vee belt may be used. Typically, on the evacuation chair, the belt is used in an inverted configuration compared to its typical use configuration. In a typical use configuration, a pulley belt has an inward face of narrow width and an outward face of wider width. In the inverted configuration preferred in the present invention, the belt has an outward face of narrow width and an inward face of wider width.

Preferably, the method includes the formation of at least two cut surfaces. Most preferably (especially from an ease of manufacture perspective) the cut surfaces are planar cut surfaces.

The third aspect of the invention may be combined with the first or second aspect and/or any optional feature thereof, to the extent that they are compatible.

Advantageously, compared with cutting a precursor belt to form a relatively wide, flat top, the preferred method of manufacture decreases the transverse length of the cutting region between a cutter blade and the belt. Thus excess fan belt material on the edges of the sliced surface is reduced. Furthermore, the quality of the cut surface can be improved. This means the belt requires no further processing to remove excess fan belt, so the manufacturing process is cheaper and easier, and the belt can have a longer service life.

In use, a typical evacuation chair should be tilted onto the rail assemblies before descending a set of stairs. The inventors of the present invention have recognised that if an operator fails to do this (e.g. as may occur due to panic in an emergency situation), and instead pushes the front wheels over the first stair, either by accident or as a consequence of no training, the evacuation chair can uncontrollably descend the stairs on its front and rear wheels. In a serious case the evacuation chair can tip up and tumble down the stairs. This can cause injury to the person seated in the chair, to other people in the path of the descending chair, and/or to the operator as he/she tries to prevent the chair from falling. Training (or lack of training) is a factor that is often underestimated by some manufacturers of evacuation chairs. In a drill situation, it may be normal for a person who has had some special training or experience to operate the evacuation chair. However, in an emergency situation (e.g. in the case of a major incident) it is very likely that the operator will have had no training in (or experience of) operating the evacuation chair.

The inventors have recognised this potential problem and preferred embodiments of the invention seek to address this problem.

Accordingly, it is preferred that the evacuation chair of any aspect of the invention has: a front leg with a front wheel attached, and a rear leg with a rear wheel attached, the front and rear wheels defining between them the length of a wheelbase region of the chair; and a stair stop positioned, when the evacuation chair is considered in plan view from above, in the wheelbase region for engaging a stair to prevent further unwanted motion of the evacuation chair down the set of stairs when the front wheel moves over the stair.

In this way, it is intended that the stair stop engages the stair before the rear wheel of the chair passes over the stair.

The stair stop may be positioned forward of the combined centre of mass of the evacuation chair and a person of 80 kg mass seated normally on the evacuation chair, when the chair is considered in plan view from above. More preferably, the stair stop is positioned, when the evacuation chair is considered in plan view from above, in the front 25% of the wheelbase region of the chair. This positioning of the stair stop near the front wheels prevents unwanted motion of the chair down stairs before the chair can build up significant downwards momentum.

The stair stop may be located at a height of less than 75 mm from a notional base plane joining the lowermost part of the rear wheel and the lowermost part of the front wheel. As will be understood, when the chair is located on level ground, this notional base plane is coincident with the ground. More preferably the stair stop is located at a height of less than 50 mm from the notional base plane.

The stair stop may extend laterally with respect to the chair. For example, stair stop may be provided by a plate member. Advantageously, this provides a wide lateral contact between the stair stop and the engaged stair to further improve the engagement of the stair stop with the stair.

The stair stop can be formed at an acute angle to the upward direction of the chair. This further improves the engagement of the stair stop with the stair.

Preferably, the stair stop includes a cushion member. Preferably, the cushion member provides cushioning when the stair stop engages a stair. This can assist in gripping the stair, thereby preventing forwards slipping of the stair stop on the stair. This can also assist in reducing or avoiding any damage to the stair by the stair stop.

Conveniently, the stair stop can be formed as part of a footrest, the footrest being positioned to support the feet of a person seated in the evacuation chair. For example, the stair stop may be provided by a rearmost region of the footrest. Advantageously, this provides the added functionality of a footrest with reduced production costs and ease of manufacture compared to providing the two components separately.

Motion of the evacuation chair down the stairs is controlled by friction between the belt of the rail assemblies and the stairs. The inventors have identified that in the event of a belt breaking (or being accidentally removed from all or part of the rail assembly) it is the rail assembly rather than the belt that contacts the stairs. The rail assemblies are typically manufactured from materials having a lower coefficient of friction than the belt, and as such, the evacuation chair can very quickly slide down the stairs or if only one belt breaks it can tip and tumble down the stairs. This can be dangerous for the person seated in the chair, the person operating the chair and other people on the stair case.

In order to address this problem, the inventors have devised a fourth aspect of the present invention.

Accordingly, in a fourth preferred aspect, the present invention provides an evacuation chair for evacuating a person down a set of stairs, the evacuation chair having:
at least one rail assembly for facilitating movement of the evacuation chair on stairs;
at least one belt, the belt being for movement around the rail assembly, to bear between the stairs and the rail assembly; and
at least one belt guide for retaining the belt on the rail assembly;
wherein the belt guide has a stopper member located to engage with a stair in the event that the belt is broken or removed from the rail assembly, to prevent unwanted sliding of the evacuation chair down the stairs.

Advantageously, the stopper member of the present invention reduces the risk of the evacuation chair uncontrollably sliding down a set of stairs if a belt breaks. Thus it improves the safety of the chair by reducing the risk of injury to the operator, the person seated in the chair and/or other people on the stairs.

The evacuation chair of the fourth aspect may be combined with any other aspect of the invention and/or any optional feature thereof, to the extent that they are compatible. Furthermore, the evacuation chair of the fourth aspect may have any one or, to the extent that they are compatible, any combination of the following optional features. However, it is expressly mentioned here that the present most preferred embodiment of the invention does not include this fourth aspect of the invention.

The stopper member may be formed as an integral part of the belt guide. This reduces the overall required number of components for the rail assemblies and hence for the evacuation chair.

The stopper member is typically located so that a contact region of the belt properly located on the rail assembly stands proud of the stopper member. In this way, provided that the belt is properly located on the rail assembly, the stopper member does not make contact with the stair.

Typically a plurality of stopper members can be provided along the belt guide. In one embodiment, the belt guide may have portions removed such that one or more remaining portions of the belt guide are stopper members. For example, the belt guide may have a castellated structure.

An evacuation chair of the first aspect may be combined with any one of, or any combination of, the features of the second or fourth aspects of the present invention, including the optional features thereof.

An evacuation chair of the second aspect may be combined with any one of, or any combination of, the features of the first or fourth aspects of the present invention, including the optional features thereof.

An evacuation chair of the fourth aspect may be combined with any one of, or any combination of, the features of the first or second aspects of the present invention, including the optional features thereof.

### BRIEF DESCRIPTION OF THE DRAWINGS

Embodiments of the invention will now be described by way of example with reference to the accompanying drawings in which:

FIG. 1 shows an evacuation chair of the prior art;

FIG. 2 shows a cross sectional view of a belt of the prior art;

FIG. 3 shows a front and side perspective view of an evacuation chair according to a preferred embodiment of the invention, in the unfolded configuration.

FIGS. 4-8 show alternate views of the evacuation chair of FIG. 3.

FIG. 9 shows a partial view of the rear of the evacuation chair of FIG. 3, from above.

FIG. 10 shows a partial view of the rear of the evacuation chair of FIG. 3, from one side.

FIGS. 11-14 show schematic cross-sectional views of belts for use in rail assemblies of embodiments of the invention.

FIG. 15 shows a partial view of a rail assembly and belt of the evacuation chair of FIG. 3.

FIGS. 16 and 17 show different views of the evacuation chair of FIG. 3, in the folded configuration.

FIG. 18 shows a partial side view of the front wheels and stair stop and footrest of the evacuation chair of FIG. 3, on level ground.

FIG. 19 shows a partial side view of the front wheels and stair stop and footrest of the evacuation chair of FIG. 3, on a stair.

FIGS. 20 and 21 show side views of the evacuation chair of FIG. 3 in configurations intermediate the unfolded and folded configurations.

### DETAILED DESCRIPTION OF THE PREFERRED EMBODIMENTS, AND FURTHER OPTIONAL FEATURES OF THE INVENTION

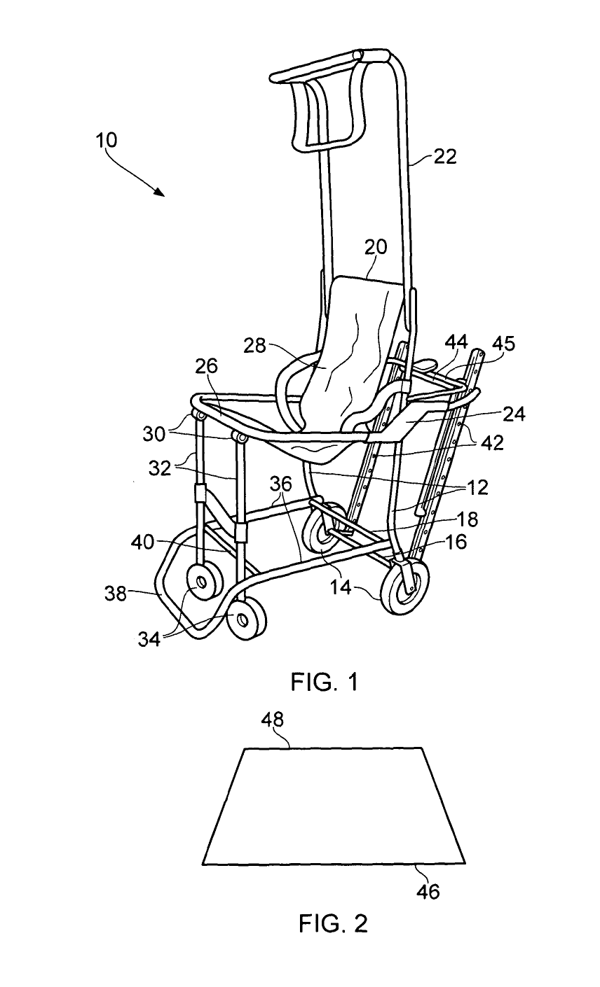

FIG. 1 shows a view of a known evacuation chair according to U.S. Pat. No. 6,561,524, and is described above and so is not described further here. However, since the preferred embodiments of the present invention build on the content of U.S. Pat. No. 6,561,524, the content of U.S. Pat. No. 6,561,524 is hereby incorporated by reference in its entirety for its relevant disclosure in respect of putting the present invention into practice.

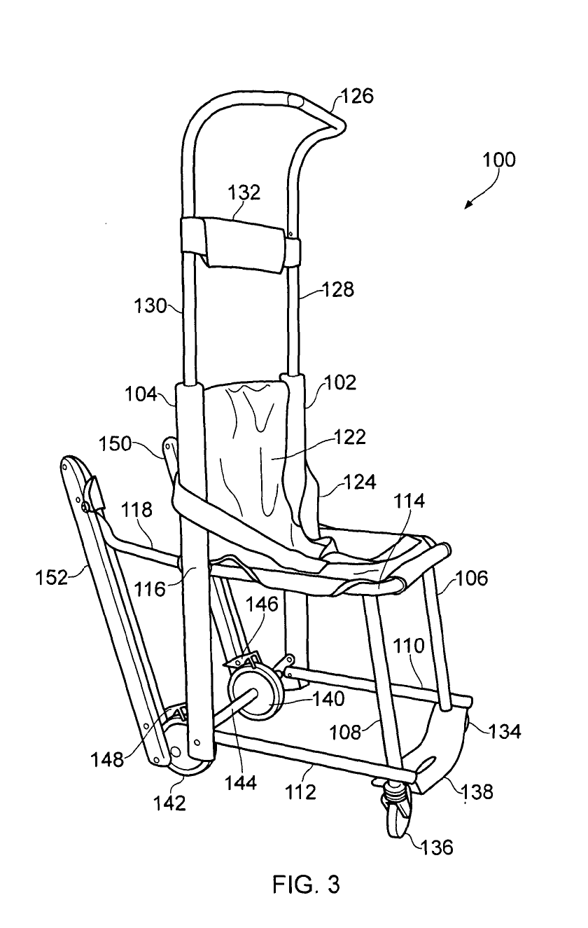

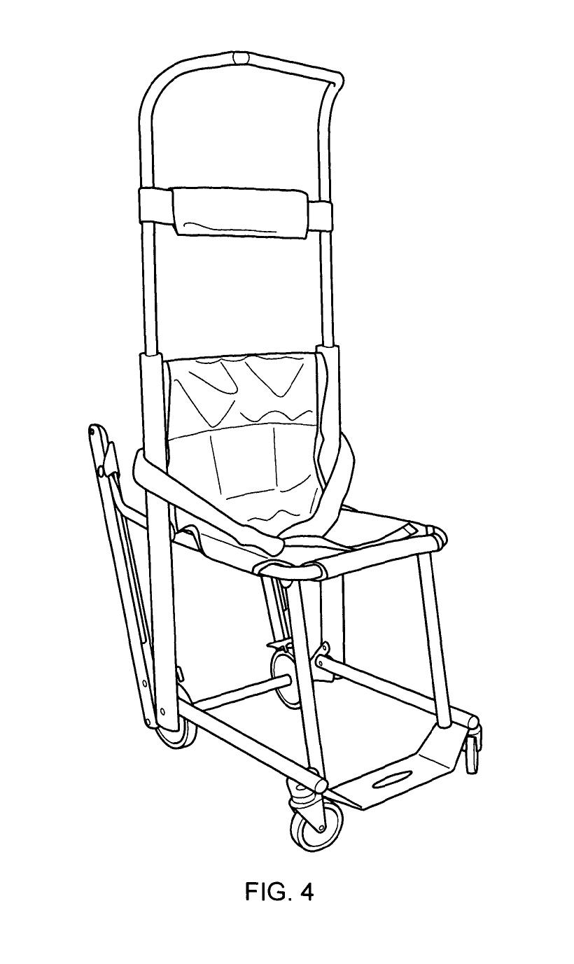

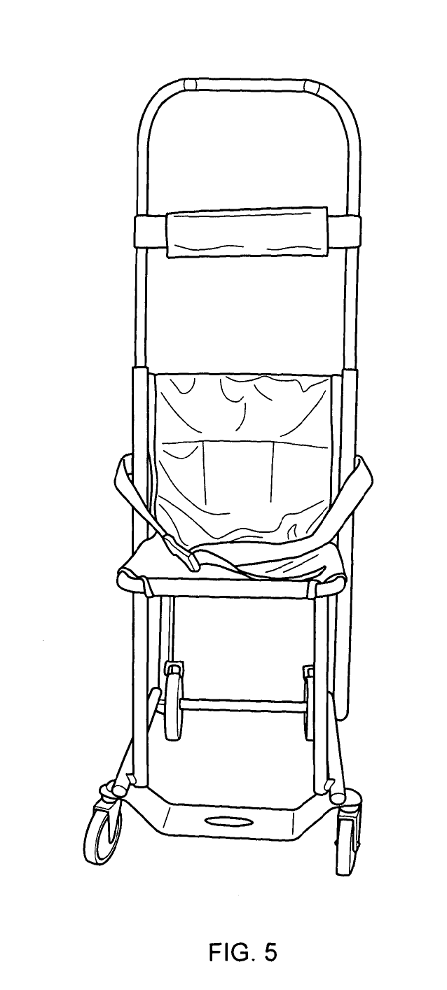

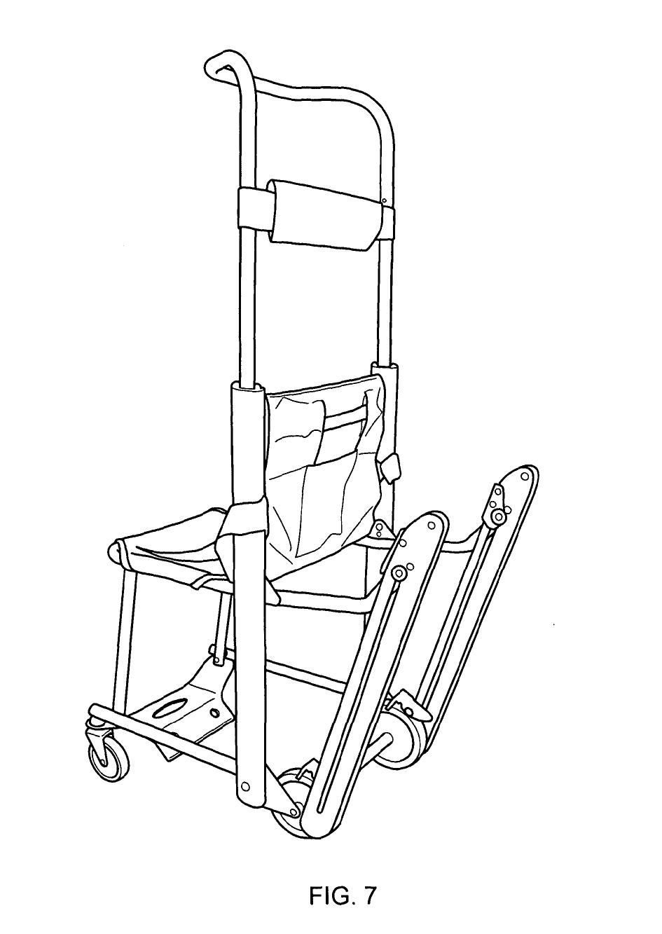

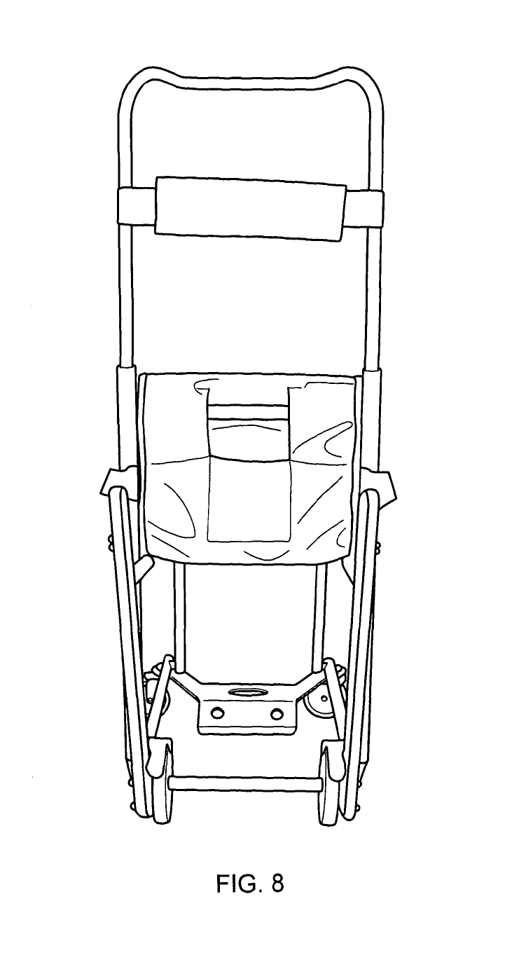

FIGS. 3-8 show progressively rotated side views of an evacuation chair according to a preferred embodiment of the invention. In these views, the evacuation chair is in the unfolded configuration. The structure of the evacuation chair will be explained particularly with reference to FIG. 3, and so reference numerals for corresponding components of the evacuation chair are not set out in FIGS. 4-8, unless the component is not indicated on FIG. 3, or is described in further detail with reference to one of FIGS. 4-8.

Evacuation chair 100 has rear legs 102, 104 and front legs 106, 108.

The lower end of rear leg 104 is connected to the lower end of front leg 108 by side support member 112. Side support member 112 is connected to the rear leg 104 by a pivot connection. Similarly, side support member 112 is connected to the lower end of front leg 108 by a pivot connection. Side support member 110 is connected to rear leg 102 and front leg 106 in a similar manner. The pivot connections allow the chair to be folded.

The upper ends of front legs 106 and 108 are connected to the rear legs 102, 104, respectively about halfway up the height of rear legs 102, 104, respectively. This connection is via seat member 114. Seat member 114 extends from a pivot connection 116 at rear leg 104 to a pivot connection at the top of front leg 106, and further extends laterally across the front of a seating region of the chair to the top of front leg 106, where it connects to the front leg by a pivot connection. The seating member 114 then extends to a pivot connection at rear leg 102. Note that the seating member 114 is integrally formed with rail support members 118, 120, described in more detail below.

Extending between the upper parts of legs 102, 104 is a backrest (not shown). A fabric seat 122 is supported from the backrest and the front and side parts of seat member 114. Flexible restraints 124 are provided to ensure that a person is held safely on the evacuation chair.

Handle 126 is formed integrally with upright extension components 128, 130. A head rest 132 is located between extension components 128, 130.

Rear legs 102, 104 are hollow. Extension components 128, 130 can be slidably extended from and slidably retracted into rear legs 102, 104, respectively. The position of the handle 126 with respect to the seat 122 may therefore be selected, typically from a discreet number of possible positions. The location of the unused parts of extension components 128, 130 inside rear legs 102, 104 improves the simplicity of construction of the evacuation chair.

Front wheels 134, 136 are provided on castors at the bottom ends of front wheels 106, 108, respectively. The use of castors allows the direction of the front wheels to be varied independently. This improves the steerability of the evacuation chair on level ground.

A footrest 138 extends between the bottom ends of front legs 106, 108, thereby providing additional rigid support to the structure of the evacuation chair. Further features of the footrest are explained in more detail below.

Rear wheels 140, 142 are rotatably mounted with respect to the lower ends of rear legs 102, 104, respectively. Rear wheels 140, 142 are independently rotatable about a common axis. Each rear wheel includes an independent axle (not shown). These axles are connected by bracing member 144, which does not rotate. Rear wheels 140, 142 are provided by foot-operable rear wheel brakes, 146, 148.

The evacuation chair is further provided with rail assemblies 150, 152. Rail assemblies 150, 152 are pivotally connected at their forward ends with respect to the lower ends of rear legs 102, 104. The rear ends of rail assemblies 150, 152 attach to rail support members 120, 118, respectively.

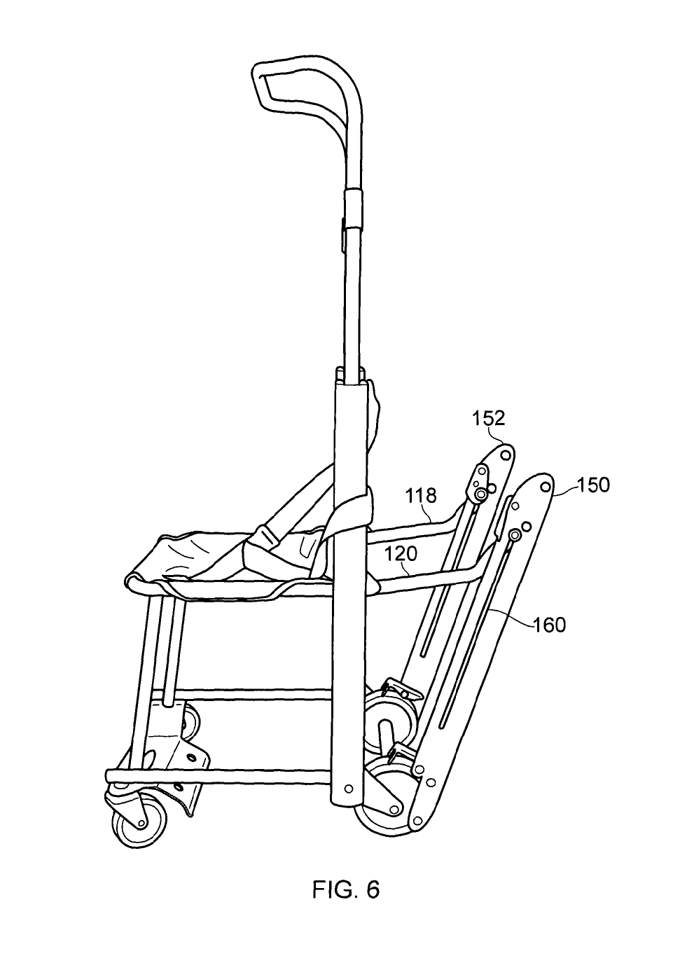

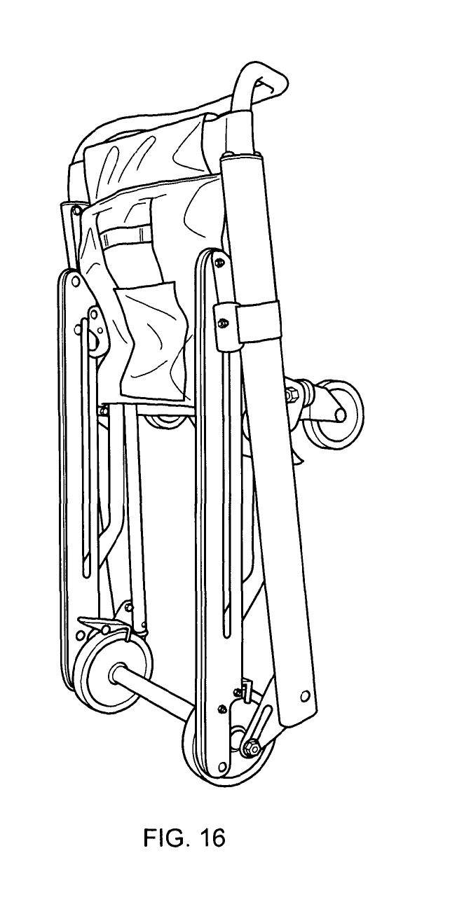

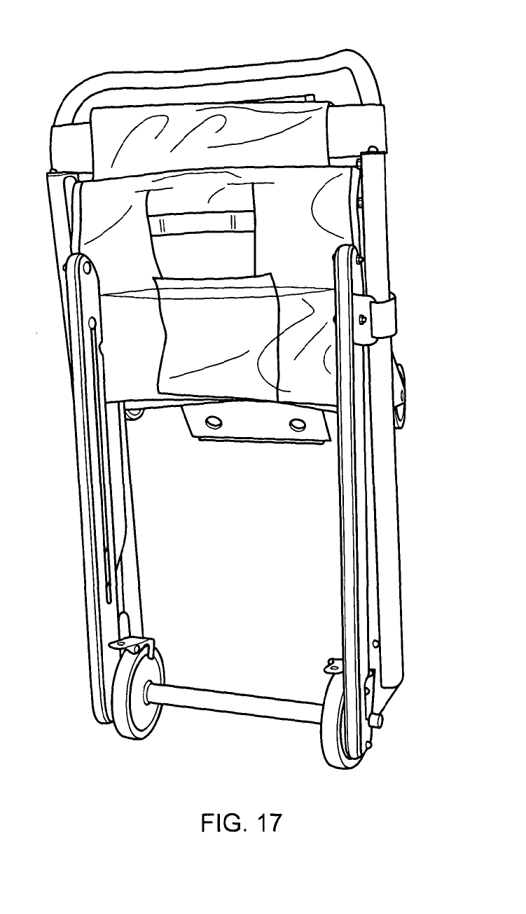

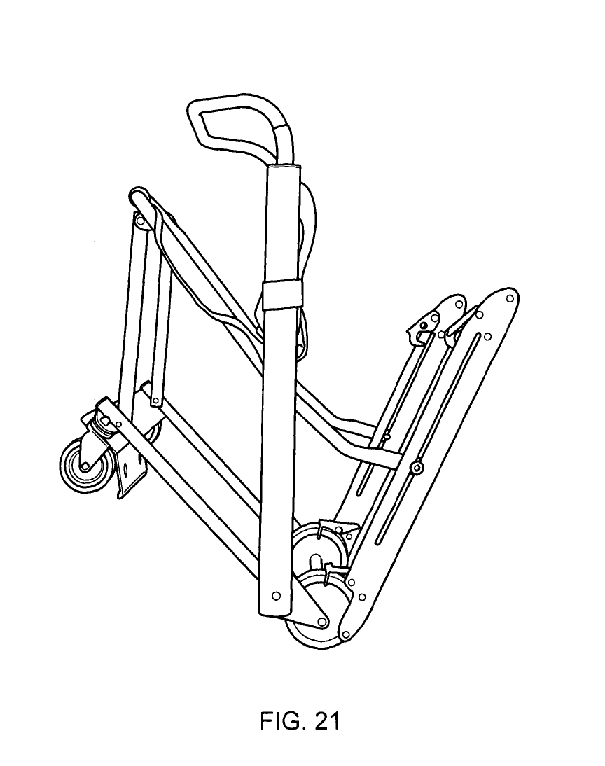

Referring now to FIG. 6, rail assemblies 150, 152 are shown in more detail, along with rail support members 120, 118. The rearwards end of rail support member 120 is able to travel in slot 160 extending from a rearwards limit of travel to a forwards limit of travel within the rail assembly 150. As will be understood, as rail support member 120 is allowed to move forwardly along slot 160, then rail support member must pivot with respect to rear leg 102. Since U-shaped seat member 114 is formed integrally with rail support members 120, 118, seat member 114 pivots upwardly with respect to the rear legs whilst rail support members 120, 118 pivot downwardly with respect to the rear legs. The result is that the chair adopts a folded configuration, as shown in FIGS. 16 and 17, in which the seat member 114, the front legs 106, 108 and the rail assemblies 150, 152 are drawn towards rear legs 102, 104. This allows the evacuation chair to adopt a compact folded configuration. FIGS. 20 and 21 show side views of the evacuation chair in configurations intermediate the unfolded and folded configurations. If FIG. 20, the handle is extended and in FIG. 21 the handle is retracted.

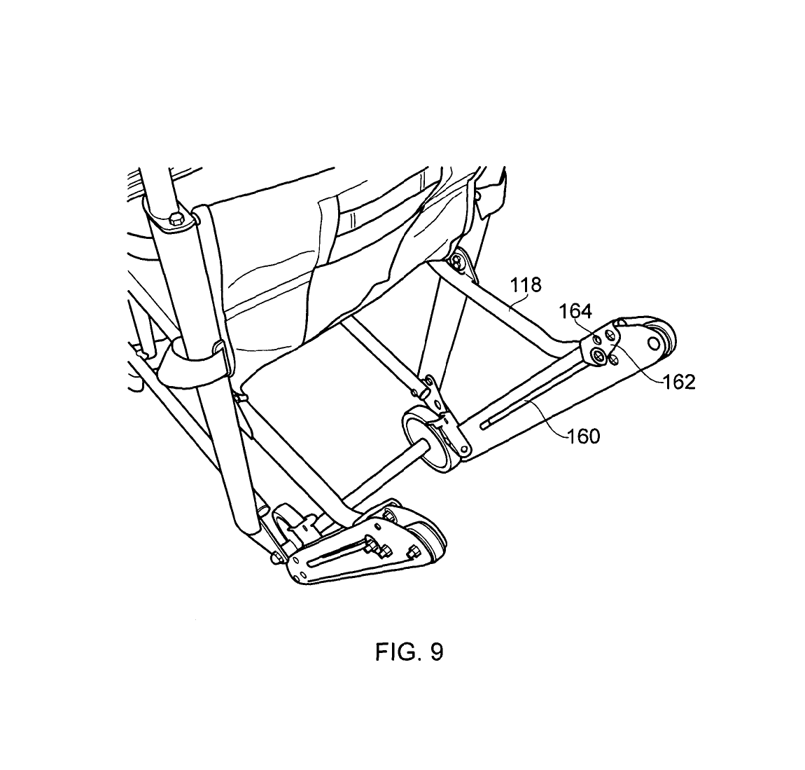

Referring now to FIG. 9, there is provided, on each rail assembly, locking hook 162. This allows the user to positively locate the rearwards end of rail support member 118 at the rearward limit of travel in slot 160. Operation of locking hook 162 allows the user to ensure that the chair will not adopt its folded configuration during use. As shown in FIG. 12, there is provided indication means 164 within locking hook 162, to indicate to the user when the locking hook has engaged to lock the rail support member.

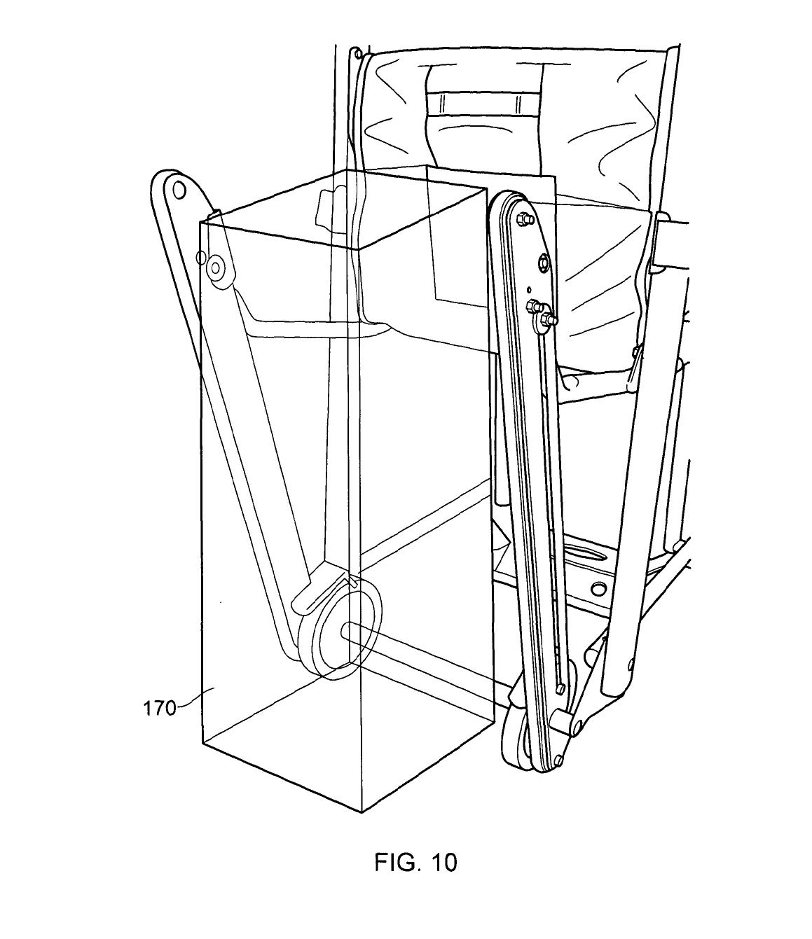

Referring now to FIG. 10, there is shown a partial view of the rear of the evacuation chair of FIG. 3. Shown schematically in FIG. 10 is leg room region 170. Within the leg room region is a clear space to accommodate the movement of the legs of the operator. The leg room region extends between the rail assemblies from the rearward ends thereof to close to the forward ends thereof. The forward limit of the leg room region is defined by bracing member 144. As will be understood, the leg room region 170 is of importance both when the evacuation chair is being wheeled along level ground and when the evacuation chair is being tipped rearwardly in order to begin a descent down stairs. [Note that in FIG. 10, a foreshortening effect means that the exact geometrical shape of legroom region 170 is not represented. It is intended that the legroom region should extend in a three dimensional shape (preferably a regular shape) having vertices located: adjacent and inwardly of each rear wheel; adjacent and inwardly of the rearwards end of each rail assembly; one vertex at ground level directly below each respective vertex located adjacent and inwardly of the rearwards end of each rail assembly; and one vertex at a height corresponding to the height of the rearwards end of the rail assembly but located respectively directly above each vertex adjacent and inwardly of each rear wheel.]

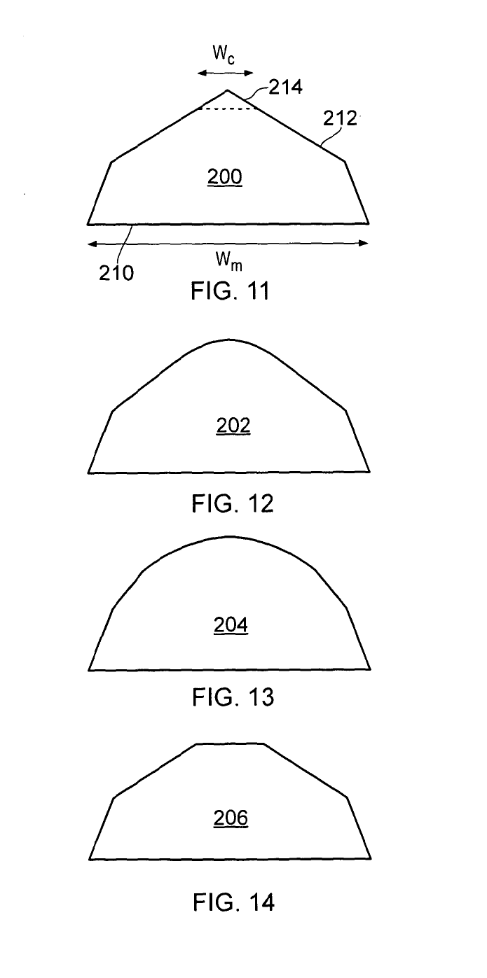

FIGS. 11 to 14 show schematic views in cross section of suitable belts for use in rail assemblies of embodiments of the invention. In FIG. 11, belt 200 has an inner surface 210 for bearing against a rail assembly of the evacuation chair. The lateral width of the inner surface 210 is Wₘ, which is the maximum lateral width of the belt 200. The belt has an outer surface 212, with an outer contact region 214 for contacting the stairs. Outer contact region 214 has a lateral width W_{c}. In this example, the ratio W_{c}/Wₘ is about 0.1.

The outer contact region is defined as the region of contact when the evacuation chair is positioned on flat ground and loaded with a mass corresponding to 80 kg mass per metre length of belt in contact with the ground (including the initial mass of the unloaded chair), as set out above.

In use, outer contact region 214 of belt 200 deforms substantially as indicated by the dotted line near the ridge of belt 200.

It is possible to manufacture the belt of FIG. 11 using a standard vehicle fan belt. The desired shape for the belt can be achieved by making two angled cuts to the fan belt in order to generate outer surface shape 212.

FIGS. 12, 13 and 14 show alternative suitable shapes for belts 202, 204 and 206.

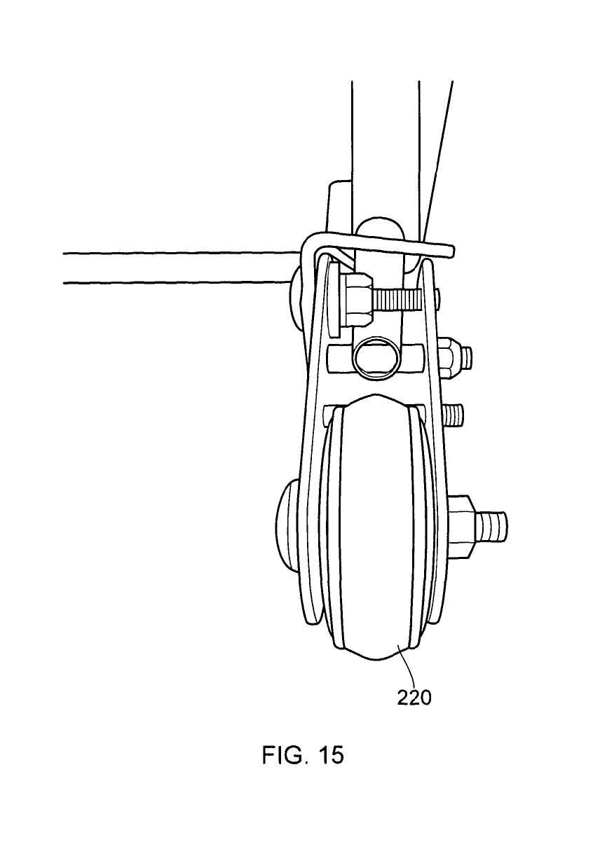

FIG. 15 shows a partial view of the rearward end of a rail assembly of the evacuation chair. This also shows belt 220 having a similar profile to belt 200 of FIG. 11. Belt 220 is shown located on one of the rollers of the rail assembly. It is clear from this view that the outer contact region of the belt is exposed for contact with the stairs.

FIGS. 16 and 17 show different views of the evacuation chair of FIG. 3, in the folded configuration.

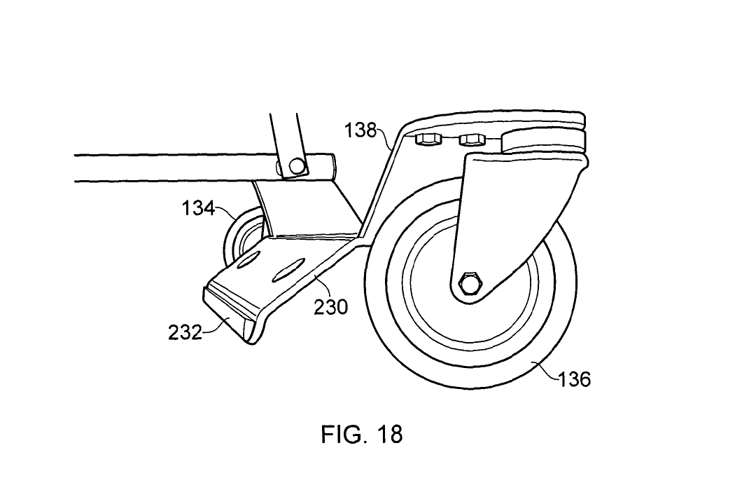

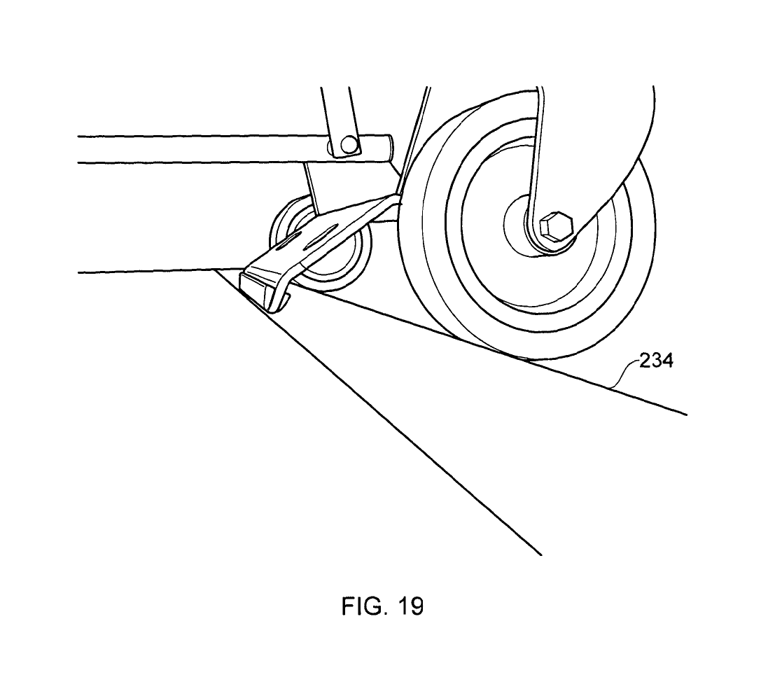

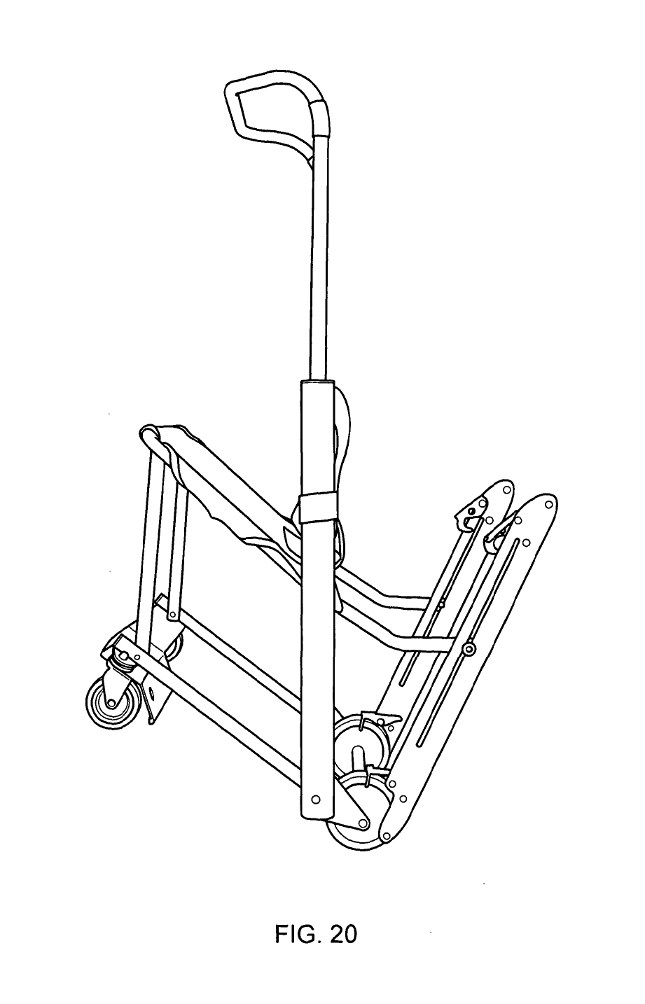

FIG. 18 shows a partial side view of the front wheels 134, 136 and the foot rest 138. Foot rest 138 includes a rearwardly-angled plate region 230 ending with a rubber cushion member 232. Together, these features constitute a stair stop. The operation of the stair stop is demonstrated in FIG. 19 in which wheels 134, 136 have started to go over stair nosing 234. Cushion member 232 engages with the stair in order to prevent further forwards or downwards movement of the evacuation chair with respect to stair nosing 234.

The stair stop is located a short distance (typically about 50 mm) above the basal plane of the evacuation chair, where the basal plane is defined as a plane containing the lowermost points of the front wheels and the rear wheels. When the evacuation chair is located in the unfolded configuration on level ground, then the basal plane is coincident with the ground. The stair stop is also located in the wheel base region (when considered in plan view of the evacuation chair) slightly behind the centres of rotation of the front wheels. This ensures that the stair stop engages the stairs before the evacuation chair has the opportunity to travel a significant distance over the stair nosing 234.

A further advantage of the preferred embodiments of the invention relate to the position of the person seated in the chair. The provision and shape of the backrest, the ample width of the seat 122, the flexibility of the seat and the rigidity of the footrest 138 improve the comfort of the person seated in the chair. This is advantageous since, e.g. during an extended incident, the person may be seated in the chair for an extended period of time.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. An evacuation chair for evacuating a person down stairs and along level ground, the evacuation chair being for operation by an operator, the evacuation chair having:
a frame and at least one front wheel and at least two rear wheels attached and rotatable with respect to the frame to allow the chair to be wheeled along level ground;
two rail assemblies attached with respect to the frame, each rail assembly extending rearwardly and upwardly from a forward end of the rail assembly to a rearward end thereof, the rail assemblies being provided for guiding the movement of the evacuation chair on stairs; wherein the chair has a folded configuration and an unfolded configuration and the rail assemblies are attached to the frame so that the rail assemblies are deployed for operation due to the chair being moved between the folded configuration and the unfolded configuration, and wherein there is provided a clear space extending throughout a legroom region between the rail assemblies from the rearward ends thereof to at least halfway towards the forward ends thereof, to accommodate the movement of the legs of the operator.

2. An evacuation chair according to claim 1 wherein, when the chair is upright on level ground, the legroom region extends downwardly from between the rail assemblies to the ground.

3. An evacuation chair according to claim 1 wherein, when the chair is upright on level ground, the legroom region extends upwardly from between the rail assemblies to at least the frame.

4. An evacuation chair according to claim 1 wherein, in the unfolded configuration, each rail assembly is supported only by a rail support member extending longitudinally between the rail assembly to the frame of the chair and by a connection between the forwards end of the rail support member and the frame.

5. An evacuation chair according to claim 4 wherein, in the unfolded configuration, the rearwards ends of the rail assemblies are not directly connected to each other.

6. An evacuation chair having at least one rail assembly for facilitating movement of the evacuation chair on stairs and at least one belt, the belt being for movement around the rail assembly, to bear between the stairs and the rail assembly, the belt having an inner surface for bearing against the rail assembly, an outer surface, and a maximum lateral width Wm;
wherein the outer surface of the belt includes an outer contact region for contacting the stairs, the outer contact region having a lateral width We such that the ratio Wc/Wm is 0.5 or lower.

7. An evacuation chair according to claim 6, wherein the belt decreases in lateral width from the maximum width Wm to the contact region.

8. An evacuation chair according to claim 6, wherein the inner surface of the belt is of maximum lateral width Wm.

9. An evacuation chair according to claim 6, wherein the contact region includes a longitudinal ridge.

10. An evacuation chair according to claim 6 wherein the rate of lateral width decrease, with distance from the inner surface of the belt, is greater near the contact region than near the position of maximum lateral width Wm.

11. An evacuation chair according to claim 6, wherein the contact region is formed from two or more planar belt surfaces.

12. A method of manufacturing an evacuation chair according to claim 6, including a step of forming the contact region of the belt by cutting from a precursor belt.
